(19) United States
(12) Patent Application Publication
(10) Pub. No.: US 2026/0358238 A1
(43) Pub. Date: Nov. 12, 2026

(54) SEMICONDUCTOR SYSTEM, DEVICE, AND METHOD THEREOF

(71) Applicant: Taiwan Semiconductor Manufacturing Co., Ltd., Hsinchu (TW)

(72) Inventors: Chun-Yuan HSU, Hsinchu (TW); Wen-Cheng CHENG, Hsinchu (TW); Che-Hung LIU, Hsinchu (TW); Ming-Cher LEE, Hsinchu (TW); Meng-Cian LI, Hsinchu (TW)

(73) Assignee: Taiwan Semiconductor Manufacturing Co., Ltd., Hsinchu (TW)

(21) Appl. No.: 19/200,272

(22) Filed: May 6, 2025

(51) Int. Cl. G01N 21/01; G01N 21/95

(52) U.S. Cl. CPC G01N 21/01; G01N 21/9501

(57) ABSTRACT

A plurality of active balancing devices are positioned on a stage and collectively support a wafer inspection tool. One or more sensors generate sensor signals indicative of an orientation of the wafer inspection tool. The active balancing devices actively adjust an orientation of the wafer inspection tool responsive to sensor signals.

### BACKGROUND

Integrated circuits are utilized in a large variety of applications, including mobile phones, tablets, laptops, vehicles, satellites, smartwatches, desktop computers, and many other kinds of devices. Typically, integrated circuits are formed from semiconductor wafers. A single semiconductor wafer undergoes a large number of semiconductor processes, including patterning processes, deposition processes, etching processes, ion implantation processes, annealing processes, cleaning processes, and various other processes. After processing of a semiconductor wafer, the wafer is diced into a large number of identical integrated circuits.

Prior to dicing of a wafer, it is beneficial to perform inspections of the wafer. If the inspections reveal that the wafer is defective, it is possible that the wafer will be scrapped. One type of wafer inspection is an optical wafer inspection, by which light sources are utilized to inspect the wafer. If the optical wafer inspection is performed improperly, it is possible that the optical wafer inspection could erroneously identify the wafer as defective. This can result in the scrapping of a properly formed wafer.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### BRIEF DESCRIPTION OF THE DRAWINGS

FIG. 1 is a block diagram of a wafer inspection system, in accordance with some embodiments.

FIG. 2 is an illustration of an active balancing device, in accordance with some embodiments.

FIG. 3A is an illustration of a wafer inspection system, in accordance with some embodiments.

FIG. 3B is a top view of a portion of the wafer inspection system of FIG. 3A, in accordance with some embodiments.

FIG. 3C is a side view of a stage, an active balancing device on the stage, and a pivot bracket, in accordance with some embodiments.

FIG. 4 is a top view of a portion of a wafer inspection system, in accordance with some embodiments.

FIG. 5 is an illustration of a wafer inspection system, in accordance with some embodiments.

FIG. 6 is an illustration of a wafer inspection system, in accordance with some embodiments.

FIG. 7A is an illustration of a wafer inspection system, in accordance with some embodiments.

FIG. 7B is a top view of a portion of the wafer inspection system of FIG. 7A, in accordance with some embodiments.

FIG. 8 is an illustration of an active balancing device, in accordance with some embodiments.

FIG. 9 is an illustration of a wafer inspection system, in accordance with some embodiments.

FIG. 10 is a flow diagram of a method for operating a wafer inspection system, in accordance with some embodiments.

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the following description, certain specific details are set forth in order to provide a thorough understanding of various embodiments of the disclosure. However, one skilled in the art will understand that the disclosure may be practiced without these specific details. In other instances, well-known structures associated with electronic components and fabrication techniques have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

The use of ordinals such as first, second and third does not necessarily imply a ranked sense of order, but rather may only distinguish between multiple instances of an act or structure.

Reference throughout this specification to “some embodiments” or “an embodiment” means that a particular feature, structure or characteristic described in connection with the embodiment is included in at least some embodiments. Thus, the appearances of the phrases “in some embodiments” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used in this specification, “light” generally refers to electromagnetic radiation of any wavelength, except where a particular band or wavelength is specified. Furthermore, as used herein, “optical systems” can include any system that receives/generates and utilizes electromagnetic radiation.

Embodiments of the present disclosure provide a wafer inspection system that helps ensure that a wafer inspection tool can properly inspect semiconductor wafers by actively leveling the wafer inspection tool and damping vibrations that could otherwise interfere with a wafer inspection process. The wafer inspection system includes a flat stage and a plurality of active balancing devices on the stage. The wafer inspection tool is placed on the active balancing devices such that the active balancing devices support the wafer inspection tool. The system includes one or more sensors that generate sensor signals indicative of an orientation or displacement of the wafer inspection tool. If the sensor signals indicate that the tool is not level or that the tool is vibrating, then the system automatically causes one or more of the active balancing devices to adjust the orientation of the tool or to otherwise damp vibrations of the tool.

In this manner, embodiments of the present disclosure help to ensure that vibrations or other misorientations do not cause the wafer inspection tool to make faulty inspections of wafers. Faulty inspections can result in erroneous analysis indicating that a wafer should be scrapped, when the wafer is, in fact, properly formed. Accordingly, embodiments of the present disclosure result in higher wafer yields, fewer scrapped wafers, and reduced time during which semiconductor processes are interrupted to determine whether or not a particular process has resulted in faulty wafers.

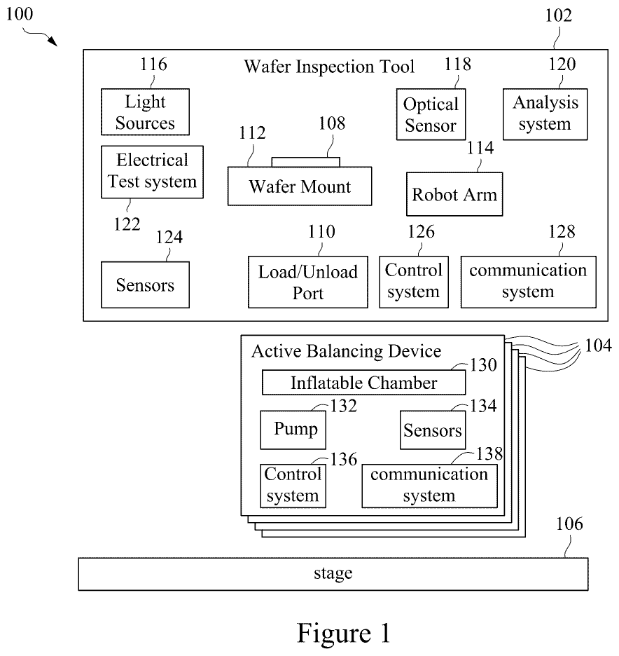

FIG. 1 is a block diagram of a wafer inspection system 100, in accordance with some embodiments. The wafer inspection system 100 includes a wafer inspection tool 102, a plurality of active balancing devices 104, and a stage 106. As will be set forth in more detail below, the components of the system 100 cooperate to help ensure that the wafer inspection tool 102 can properly inspect semiconductor wafers 108 without disruption from vibrations or from tilting of the wafer inspection tool 102.

Semiconductor wafers undergo a large number of semiconductor processes in order to form integrated circuits within the wafers. After formation of the integrated circuits, the semiconductor wafers will be diced to singulate individual integrated circuits. Individual integrated circuits are then packaged and installed in mobile phones, laptops, tablets, desktop computers, laptop computers, smartwatches, vehicles, and a large number of other types of electronic devices or systems.

In some embodiments, processing of a semiconductor wafer 108 includes forming a plurality of transistors in conjunction with a semiconductor substrate of the semiconductor wafer 108. After formation of the transistors, source, drain, and gate contacts are formed to facilitate providing signals and currents to/from the terminals of the transistors. A dielectric stack is then formed over the transistors including a large number of dielectric layers. A plurality of levels of metal tracks are formed in the dielectric layers. Conductive vias are formed in the dielectric layers, electrically connecting metal tracks of one level to metal tracks of another level. Formation of these features calls for, in some embodiments, the epitaxial growth processes, photolithography processes, ion implantation processes, dielectric deposition processes, metal deposition processes, annealing processes, cleaning processes, chemical mechanical planarization processes, and other types of processes.

It is beneficial to inspect the semiconductor wafers after processing is complete and prior to dicing. It is also beneficial to inspect the semiconductor wafers at intermediate stages of processing. Such inspections can determine whether or not the semiconductor wafers have been properly formed, or whether particular processes have been successfully completed.

In some embodiments, the wafer inspection tool 102 is utilized to inspect semiconductor wafers 108. In some embodiments, the wafer inspection tool 102 inspects semiconductor wafers 108 after processing of the semiconductor wafers 108 is substantially complete. In some embodiments, the wafer inspection tool 102 inspects semiconductor wafers at intermediate stages of processing.

In some embodiments, the wafer inspection tool 102 utilizes highly sensitive to determine whether features have been properly formed in the semiconductor wafers. In some cases, the features can include patterns of features with critical dimensions less than 10 nm. If the wafer inspection tool 102 is not properly oriented or subject to vibrations, it is possible that sensitive testing processes can be disrupted and can erroneously indicate that features have not been properly formed. As will be set forth in more detail below, the system 100 utilizes the active balancing devices to damp vibrations and to maintain proper orientation of the wafer inspection tool 102. Further details regarding testing processes are provided below.

The wafer inspection tool 102 includes one or more load/unload ports 110. The load/unload ports 110 facilitate loading semiconductor wafers 108 into the wafer inspection tool 102 for testing. The load/unload ports 110 facilitate outputting wafers 108 from the wafer inspection tool 102, after testing.

In some embodiments, the load/unload ports 110 include one or more dedicated loading ports. The one or more dedicated loading ports receive semiconductor wafers to be inspected. The load/unload ports 110 include one or more dedicated unloading ports. The dedicated unloading ports are utilized to unload wafers 108 after the wafers 108 have been inspected.

In some embodiments, the wafer inspection tool 102 includes a wafer mount 112. The wafer mount 112 supports a wafer one awaits during inspection of the wafer 108. The wafer mount 112 can include an electrostatic chuck that securely holds a wafer 108 during inspection. Alternatively, the wafer mount 112 can include fasteners, or other types of mechanisms that securely hold a wafer 108 in place during inspection. In some embodiments, the wafer inspection tool 102 includes multiple wafer mounts 112.

In some embodiments, the wafer inspection tool 102 includes one or more robot arms 114. The robot arms 114 carry semiconductor wafers 108 between the load/unload ports 110 and the wafer mount 112. In some embodiments, a single robot arm 114 transfers wafers 108 from a load/unload port 110 to a wafer mount 112, and transfers wafers 108 from the wafer mount 112 to the load/unload ports 110. In some embodiments, one or more dedicated robot arms transfers wafers from a load port to the wafer mount 112. In some embodiments, one or more dedicated robot arms 114 transfer wafers 108 from the wafer mount 112 to an unload port after inspection. Various types of robot arms 114 can be utilized without departing from the scope of the present disclosure.

In some embodiments, the wafer inspection tool 102 is an optical wafer acceptance test (OWAT) tool. The wafer inspection tool 102 includes one or more light sources 116 and one or more optical sensors 118. The one or more light sources 116 output light the wafer one awaits while the wafer is on the mount 112. The optical sensors 118 sense light from the one or more light sources 116 after reflection, refraction, or scattering from the wafer 108. The nature of the light sensed by the optical sensors 118 can indicate whether or not the wafer 108 has been properly processed.

In some embodiments, the light sources 116 include one or more lasers. The lasers and the optical sensors 118 can utilize phase shift interferometry to precisely measure surface topography and thickness variations with a high degree of accuracy. In some embodiments, the lasers and the optical sensors 118 utilize scatterometry to determine surface roughness and the quality of layers on the wafer 108. Various types of light sources and optical sensors 118 can be utilized to perform optical tests on the wafers 108 without departing from the scope of the present disclosure.

In some embodiments, the wafer inspection tool 102 includes an analysis system 120. The analysis system 120 is coupled to the optical sensors 118. The analysis system 120 receives sensor signals or sensor data from the optical sensors 118. The analysis system 120 analyzes the sensor signals or sensor data to determine whether the wafer 108 is properly formed or defective. In some embodiments, if the wafer analysis system 120 determines that a wafer 108 is defective, then the wafer 108 may be scrapped. In some cases, multiple wafers 108 may be scrapped based on a determination of a defective wafer by the analysis system 120.

In some embodiments, the wafer inspection tool 102 includes an electrical test system 122. In some embodiments, the electrical test system 122 utilizes probe cards or other types of probes to physically contact conductive terminals or other locations at the surface of the wafer 108. Electrical signals are then applied and measured via the probes. This can include daikon die testing that checks the functionality of each individual die on the wafer 108. This can also include wafer level testing that performs measurements across multiple dies at once. This can help identify issues such as short circuits, open circuits, or other performance problems. Electrical testing can include direct-current tests to evaluate the basic functionality of the wafers' components, such as resistance, voltage, and current. Electrical testing can include alternating current tests that evaluate performance of the wafer 108 at high frequencies. Various types of electrical testing can be performed without departing from the scope of the present disclosure.

In some embodiments, the wafer inspection tool 102 includes a plurality of sensors 124. In some embodiments, the sensors 124 generate sensor signals indicative of whether or not the wafer inspection tool 102 is level. The sensors 124 generate sensor signals indicative of vibrations of the wafer inspection tool 102.

In some embodiments, the sensors 124 are arranged at selected locations of the wafer inspection tool 102. In some embodiments, one or more sensors 124 are arrayed at various locations on a bottom interior surface, or a bottom exterior surface of the wafer inspection tool 102. In some embodiments, one or more sensors 124 are arrayed at various locations on side interior surfaces or side exterior surfaces of the wafer inspection tool 102. In some embodiments, one or more sensors 124 are arrayed at various locations on a top interior surface or top exterior surface of the wafer inspection tool 102.

In some embodiments, the sensors 124 include inertial sensors. In some embodiments, the inertial sensors include accelerometers. In some embodiments, the inertial sensors include single axis accelerometers. In some embodiments, the inertial sensors include triaxial accelerometers that sense acceleration or force in three mutually orthogonal spatial dimensions. The accelerometers sense an orientation of the wafer inspection tool 102. For example, the accelerometers sense whether or not the wafer inspection tool 102 is tilted or is otherwise not level. In some embodiments, the accelerometers sense vibrations of the wafer inspection tool 102.

In some embodiments, the inertial sensors include gyroscopes. In some embodiments, the inertial sensors include single axis gyroscopes. In some embodiments, the inertial sensors include triaxial gyroscopes that sense oscillation around three mutually orthogonal spatial dimensions. The gyroscopes can assist in sensing vibrations or tilting of the wafer inspection tool 102.

The sensors 124 output sensor signals. The sensor signals are indicative of an orientation of the wafer inspection tool 102. The sensor signals are indicative of vibrations of the wafer inspection tool 102. Even small amounts of tilting or vibration can cause defects in sensitive wafer inspection measurements of the wafer inspection tool 102. Accordingly, as will be set forth in more detail below, the sensor signals are utilized to enable the active balancing devices 104 to adjust the orientation of the wafer inspection tool 102 or to damp vibrations of the wafer inspection tool 102.

In some embodiments, the sensors 124 include a temperature sensor. The temperature sensor measures temperature within a controller range of +/−1 °C. The high sensitivity of the temperature sensor benefit the anti-vibration function as some vibration measurements are temperature sensitive.

In some embodiments, the wafer inspection tool 102 includes a control system 126. The control system 126 can include one or more memories, one or more processors, and communication resources. The control system 126 controls operation of the wafer inspection tool 102. Controlling operation of the wafer inspection tool 102 includes controlling operation of the load/unload port 110, the robot arm 114, the light sources 116, the optical sensors 118, the analysis system 120, the electrical test system 122, the sensors 124.

In some embodiments, the wafer inspection tool 102 includes a communication system 128. The communication system 128 is communicatively coupled to the control system 126 and is controlled by the control system 126. The communication system 128 outputs data from the wafer inspection tool 102 to devices or systems external to the wafer inspection tool 102. The communication system 128, receives signals or data from devices or systems external to the wafer inspection tool 102. In some embodiments, the communication system 128 outputs sensor data from the sensors 124 to the active balancing devices 104. In some embodiments, the communication system 128 outputs commands from the control system 126 to the active balancing devices 104.

In some embodiments, the communication system 128 includes wireless communication resources that facilitate wireless communication between the wafer inspection tool 102 and external devices or systems. In some embodiments, the communication system 128 includes wired communication resources that facilitate wired communication between the wafer inspection tool 102 and external devices or systems.

In some embodiments, the active balancing devices 104 are each positioned on the stage 106. The active balancing devices 104 collectively support the wafer inspection tool 102 above the stage 106. The active balancing devices actively adjust to maintain a level orientation of the wafer inspection tool 102 and to damp vibrations of the wafer inspection tool 102.

In some embodiments, each active balancing device 104 includes an inflatable chamber 130. The active balancing device 104 actively adjusts the inflation level of the inflatable chamber 130 to actively adjust the orientation of the wafer inspection tool 102 and to damp vibrations of the wafer inspection tool 102.

In some embodiments, the inflatable chamber 130 is placed below a top support surface of the active balancing device 104. Inflating the inflatable chamber 130 raises the support surface. Raising the support surface causes a corresponding rise in the portion of the wafer inspection tool 102 directly above the support surface. Deflating the inflatable chamber 130 lowers the support surface. Lowering the support surface causes a corresponding lowering in the portion of the wafer inspection tool 102 directly above the support surface. Inflating the inflatable chamber 130 includes increasing a pressure within the inflatable chamber 130. Deflating the inflatable chamber 130 includes decreasing a pressure within the inflatable chamber 130.

In some embodiments, the active balancing device 104 includes a pump 132. The pump 132 pumps air or another fluid into the inflatable chamber 130 to inflate the inflatable chamber 130. This causes a raising of the support surface. The pump 132 pumps air or another fluid out of the inflatable chamber 130 deflate the inflatable chamber 130. This causes a lowering of the support surface.

In some embodiments, the active balancing device 104 includes one or more sensors 134. In some embodiments, the sensors 134 generate sensor signals indicative of vibrations of the active balancing device 104, the stage 106, or the wafer inspection tool 102.

In some embodiments, the sensors 134 include inertial sensors. In some embodiments, the inertial sensors include accelerometers. In some embodiments, the inertial sensors include single axis accelerometers. In some embodiments, the inertial sensors include triaxial accelerometers that sense acceleration or force in three mutually orthogonal spatial dimensions. The accelerometers sense an orientation of the active balancing device 104 or vibrations of the active balancing device 104, the stage 106, or the wafer inspection tool 102.

In some embodiments, the inertial sensors include gyroscopes. In some embodiments, the inertial sensors include single axis gyroscopes. In some embodiments, the inertial sensors include triaxial gyroscopes that sense oscillation around three mutually orthogonal spatial dimensions. The gyroscopes can assist in sensing vibrations of the active balancing device 104, the stage 106, or the wafer inspection tool 102.

The sensors 134 output sensor signals. The sensor signals are indicative of an orientation of the active balancing device 104 or vibrations of the active balancing device 104, the stage 106, or the wafer inspection tool 102. In some embodiments, the sensors 134 include MEMS sensor configured to generate vibrations to offset or damp vibrations so that the wafer inspection tool 102 does not experience significant vibrations.

In some embodiments, the active balancing device 104 includes a control system 136. The control system 136 includes one or more memories, one or more processors, and communication resources. The control system 136 controls operation of the active balancing device 104. For example, the control system 136 receives the sensor signals from one or both of the sensors 124 and the sensors 134. The control system 136 controls the pump 132, to adjust the inflation of the inflatable chamber 130 responsive to the sensor signals. The control system 136 controls the pump 132 to damp vibrations and to adjust or maintain an orientation of the wafer inspection tool 102.

In some embodiments, the active balancing device 104 includes a communication system 138. The communication system 138 is communicatively coupled to the control system 136 and is controlled by the control system 136. The communication system 138 outputs data from the active balancing device 104 to devices or systems external to the wafer active balancing device 104. The communication system 138, receives signals or data from devices or systems external to the active balancing device 104.

In some embodiments, the communication system 138 receives sensor data from the sensors 124 of the wafer inspection tool 102 or from other sensors. In some embodiments, the communication system 138 receives commands from the wafer inspection tool 102, or from other external sources such as an external control system (not shown) of the system 100. In some embodiments, the communication system 138, receives external commands or sensor data and provides external commands or sensor data to the control system 136. The control system 136 then adjusts the inflatable chamber 130, in response to the sensor data or external commands.

In some embodiments, the communication system 138 includes wireless communication resources that facilitate wireless communication between the active balancing device 104 and external devices or systems. In some embodiments, the communication system 138 includes wired communication resources that facilitate wired communication between the active balancing device 104 and external devices or systems.

In some embodiments, the stage 106 includes a plastic material that passively damage vibrations. In some embodiments, the stage 106 includes a metal material. In some embodiments, the stage 106 includes a ceramic material. The material of the stage 106 is selected to facilitate a stable orientation of the wafer inspection tool 102 and to enable the active balancing devices 104 to actively adjust the wafer inspection tool 102.

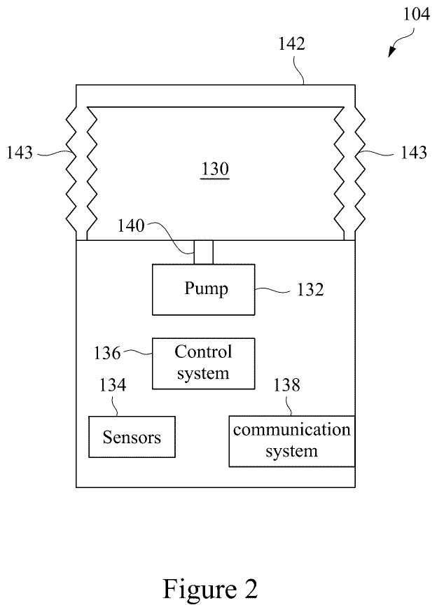

FIG. 2 is an illustration of an active balancing device 104, in accordance with some embodiments. The active balancing device 104 of FIG. 2 is one example of an active balancing device 104 of FIG. 1. In some embodiments, each of the active balancing devices 104 of the system 100 of FIG. 1 is substantially identical.

The active balancing device 104 includes an inflatable chamber 130, and a support surface 142 above the inflatable chamber 130. The inflatable chamber 130 includes sidewalls 143. The sidewalls 143 of the inflatable chamber 130 are selected to enable inflation and deflation of the inflatable chamber 130. In some embodiments, the sidewalls 143 of the inflatable chamber 130 include a flexible material that can deform to facilitate inflating and deflating of the inflatable chamber 130. In some embodiments, the sidewalls 143 of the inflatable chamber 130 have an accordion configuration to enable stretching and compressing with the inflation and deflation of the inflatable chamber 130.

In some embodiments, the support surface 142 is substantially rigid. Accordingly, the support surface 142 includes, in some embodiments, a rigid plastic material, a metal material, or other suitable materials. The support surface 142 is configured to support the wafer inspection tool 102. As will be described in more detail below, supporting the wafer inspection tool 102 includes directly contacting the wafer inspection tool 102, directly contacting a flexible bracket of the wafer inspection tool 102, or directly contacting a platform positioned between the active balancing device 104 and the wafer inspection tool 102.

In some embodiments, the active balancing device 104 includes a pump 132, sensors 134, a control system 136, and a communication system 138 as described in relation to FIG. 1. The components of the active balancing device 104 cooperate to adjust the orientation of the wafer inspection tool 102 and to damp vibrations of the wafer inspection tool 102, as described in relation to FIG. 1.

In some embodiments, the active balancing device 104 includes one or more fluid channels 140 coupled between the pump 132 and the inflatable chamber 130. The one or more fluid channels 140 enable a fluid to be pumped into the inflatable chamber 130 inflating inflatable chamber 130. The one or more fluid channels 140 enable fluid to be pumped out of the inflatable chamber 130 deflating the inflatable chamber 130. The active balancing device 104 can include other components or configurations without departing from the scope of the present disclosure.

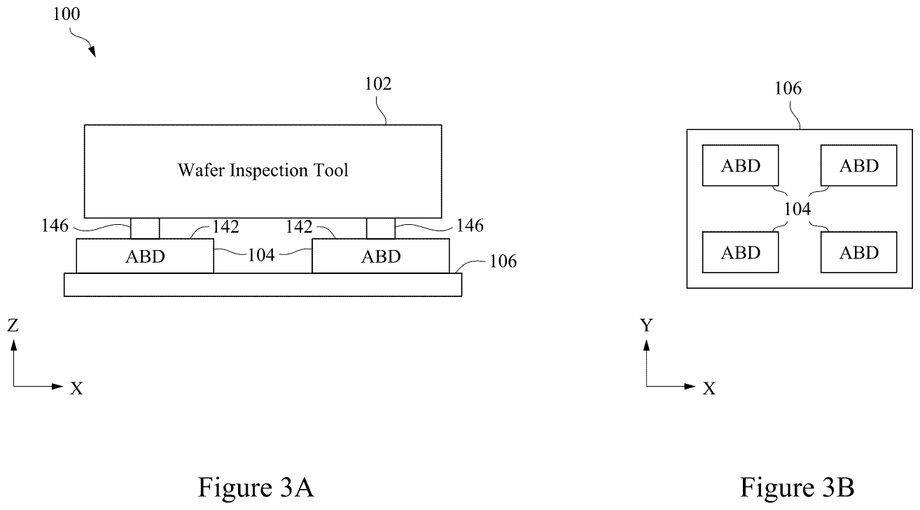

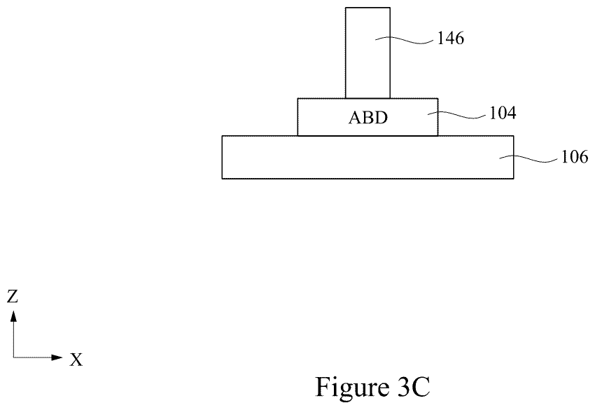

FIG. 3A is a side view of a wafer inspection system 100, in accordance with some embodiments. FIG. 3B is a top view of the wafer inspection system 100 of FIG. 3A, in accordance with some embodiments. The wafer inspection system 100 of FIGS. 3A and 3B is one example of the wafer inspection system 100 of FIG. 1. In FIGS. 3A and 3B, the axes X and Y correspond to lateral or horizontal axes. The axis Z corresponds to the vertical axis.

The system 100 includes a wafer inspection tool 102, in accordance with some embodiments. The wafer inspection tool 102 can include the components and functionality described in relation to FIG. 1. In FIG. 3A, the wafer inspection tool 102 includes a plurality of pivot brackets 146. The pivot brackets 146 are coupled to a bottom surface of the wafer inspection tool 102.

The system 100 includes a stage 106 and the plurality of active balancing devices (ABD) 104, in accordance with some embodiments. The active balancing devices 104 are arrayed on a top surface of the stage 106. Each pivot bracket 146 is positioned on a support surface 142 of a respective active balancing device 104. Accordingly, the active balancing devices 104 collectively support the wafer inspection tool 102 via the pivot brackets 146.

The active balancing devices 104 include the components and functionality described in relation to FIGS. 1 and 2. In particular, the active balancing devices 104 can inflate and deflate to adjust a position and damp the vibrations of the wafer inspection tool 102.

FIG. 3B illustrates a top view of the system 100 of FIG. 3A, except that the wafer inspection tool 102 is not shown. Instead, the positions of the active balancing devices 104 are shown on the top surface of the stage 106. In the example FIG. 3B, four active balancing devices are arrayed on the stage 106. Each active balancing device 104 is in contact with a pivot bracket 146. In some embodiments, the number of active balancing devices 104 is greater than or equal to two.

In some embodiments, each active balancing device 104 has a width in the X direction less than 50 cm. In some embodiments, each active balancing device 104 has a width in the Y direction less than 50 cm. In some embodiments, each active balancing device 104 has a height in the Z direction less than 60 cm at full inflation. Other dimensions can be utilized for the active balancing devices 104 without departing from the scope of the present disclosure.

In some embodiments, the stage 106 has a width in the X direction less than 2 m. In some embodiments, the stage 106 has a width in the Y direction less than 1.9 m. In some embodiments, the stage has a thickness in the Z direction. In some embodiments, the lateral dimensions of the stage 106 are selected to be greater than or equal to the lateral dimensions of the wafer inspection tool 102.

FIG. 3C is a side view of a stage 106, an active balancing device 104 on the stage 106, and a pivot bracket 146 with a larger vertical dimension than lateral dimensions, in accordance with some embodiments. This and other shapes can be utilized for pivot brackets 146 without departing from the scope of the present disclosure.

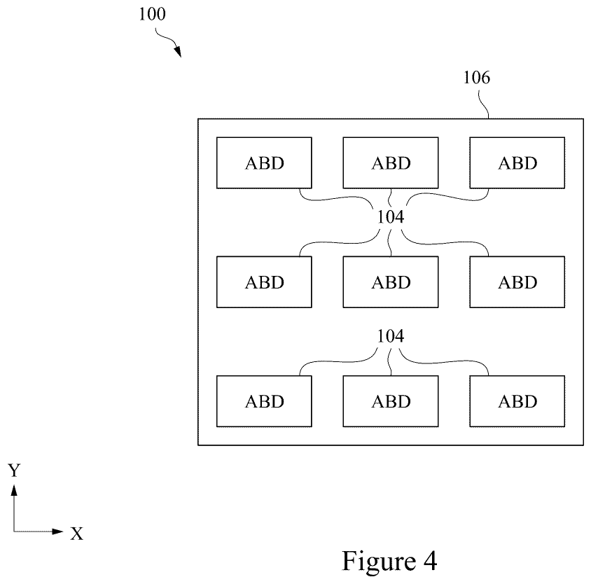

FIG. 4 illustrates a top view of a wafer inspection system 100, in accordance with some embodiments. The wafer inspection system 100 of FIG. 4 is one example of a wafer inspection system 100 of FIG. 1. In FIG. 4, the wafer inspection tool 102 is not shown. Instead, the positions of the active balancing devices 104 are shown on the top surface of the stage 106. In the example FIG. 4, nine active balancing devices 104 are arrayed on the stage 106. In some embodiments, each active balancing device 104 is in contact with a pivot bracket 146.

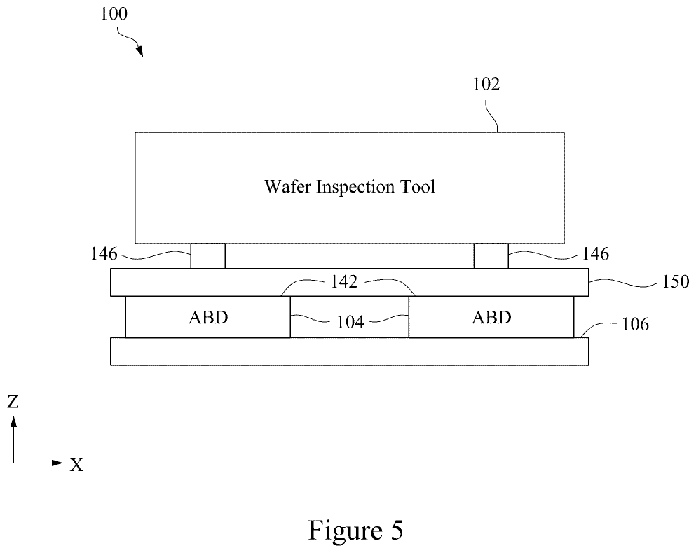

FIG. 5 is an illustration of a wafer inspection system 100, in accordance with some embodiments. The wafer inspection system 100 of FIG. 5 is similar to the wafer inspection system 100 of FIG. 3A, except that a platform 150 is positioned between the active balancing devices, and the pivot brackets 146. In particular, the bottom surface of the platform 150 is in contact with the support surface 142 of each of the active balancing devices 104. A top surface of the platform 150 is in contact with a bottom surface of each of the pivot brackets 146. The active balancing devices damp vibrations, and adjust the orientation of the wafer inspection tool 102 via the platform 150.

In the example of FIG. 5, the platform 150 is a unitary platform in contact with each of the active balancing devices 104. However, in some embodiments, a plurality of separate platforms 150 are each positioned between one or more active balancing devices 104 and the wafer inspection tool 102. In some embodiments, the platform 150 has similar lateral dimensions as the stage 106. In some embodiments, the platform 150 is made of a rigid material such as a rigid plastic, metal, or ceramic material. The presence of the platform 150 helps to ensure that overall stability is consistent. In some embodiments, the vertical distance between the bottom of the stage 106 and the top surface of the platform 150 is less than 60 cm.

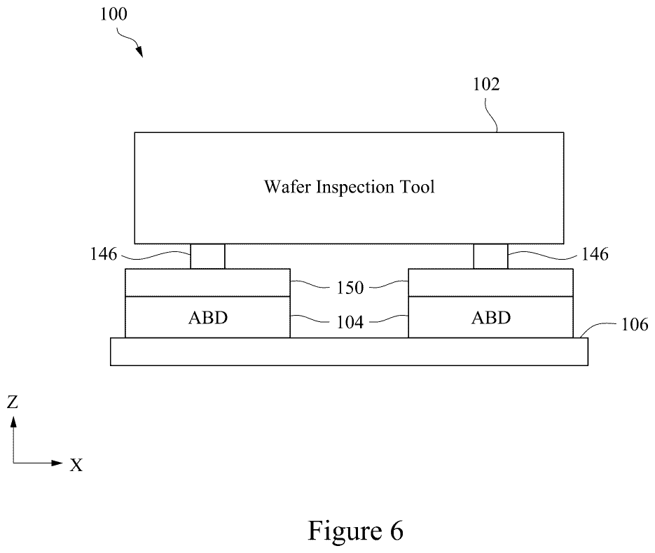

FIG. 6 is an illustration of a wafer inspection system 100, in accordance with some embodiments. The wafer inspection system 100 of FIG. 6 is similar to the wafer inspection system 100 of FIG. 5, except that a plurality of platforms 150 are each positioned between a respective active balancing device 104, and a pivot bracket 146.

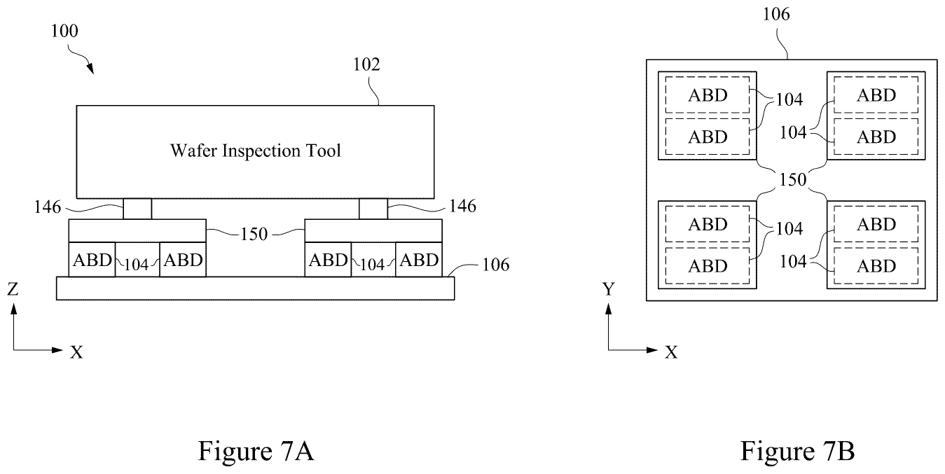

FIG. 7A is an illustration of a wafer inspection system 100, in accordance with some embodiments. The wafer inspection system 100 of FIG. 7A is similar to the wafer inspection system 100 of FIG. 6, except that each platform 150 is positioned on two active balancing devices 104. Each platform 150 has a top surface in contact with one of the pivot brackets 146. Each pair of active balancing devices 104 are spaced apart from each other by a selected distance.

FIG. 7B is a top view of system 100 of FIG. 7A, in accordance with some embodiments. FIG. 7B does not illustrate the wafer inspection tool 102. The pairs of active balancing devices 104 are shown in dashed lines below the platforms 150. Other configurations of platforms 150 and active balancing devices 104 can be utilized without departing from the scope of the present disclosure.

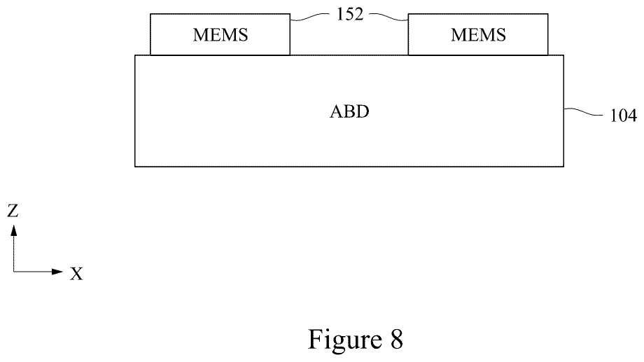

FIG. 8 is an illustration of an active balancing device 104, in accordance with some embodiments. The active balancing device 104 of FIG. 8 can include the same components and structures described in relation to FIGS. 1 and 2. However, the active balancing device 104 includes a pair of MEMS devices 152, in accordance with some embodiments. In practice, one or more MEMS devices 152 can be mounted on the top surface of the active balancing device 104.

The MEMS devices 152 are configured to vibrate in order to counteract submicron level vibrations of the wafer inspection tool 102. In some embodiments, when the active balancing devices 104 include MEMS devices 152, the platforms 150 or the pivot brackets 146 are in direct contact with the top surface of the MEMS devices. In some embodiments, the control circuit of the active vibration device is communicatively coupled to the MEMS devices 152. The control circuit can cause the MEMS devices 152 to vibrate in response to the sensor signals indicating vibrations of the wafer inspection tool 102. Other configurations of MEMS devices 152 with an active balancing device 104 can be implemented without departing from the scope of the present disclosure. Installation of MEMS devices 152 can enhance vibration detection.

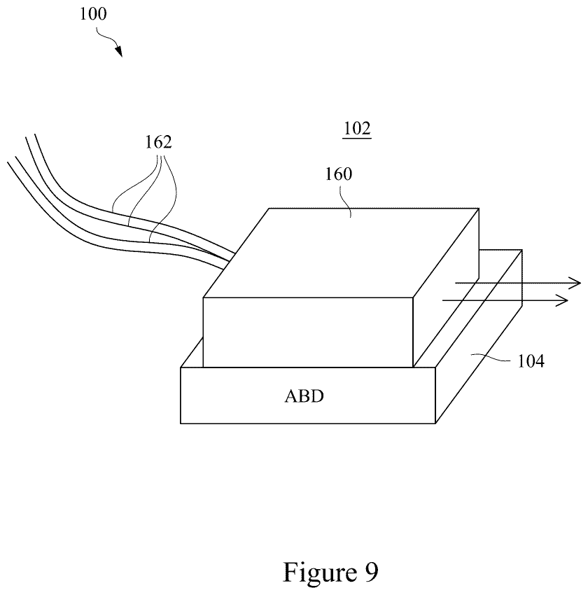

FIG. 9 is an illustration of a wafer inspection system 100, in accordance with some embodiments. In FIG. 9, in active balancing device 104 is positioned directly below a laser 160 of the wafer inspection tool 102. The active balancing device 104 can actively control the stability and direction of the laser 160 via vibration damping and inflation/deflation as described previously. In some embodiments, the laser includes a fiber array 162 positioned very close to the wafer. The active balancing devices 104 help avoid vibrations that could affect measurements performed in conjunction with the laser 160.

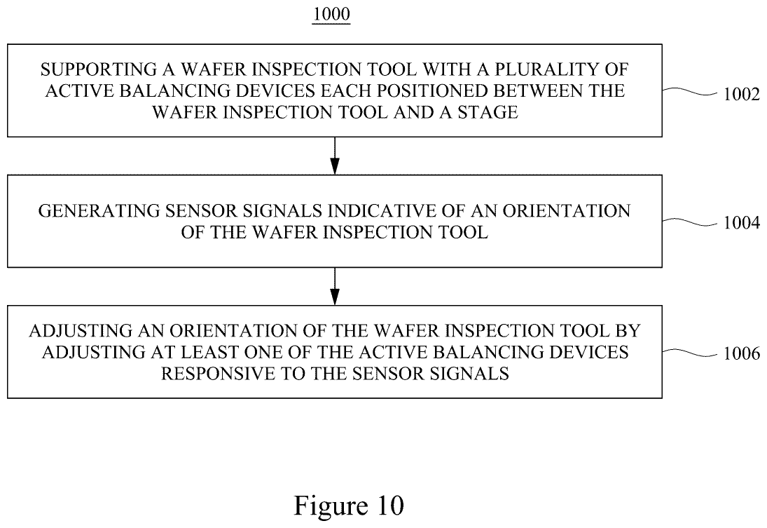

FIG. 10 is a flow diagram of a method 1000 for operating a wafer inspection system, in accordance with some embodiments. The method 1000, systems, components, and processes described in relation to FIGS. 1-9. At 1002, the method 1000 includes supporting a wafer inspection tool with a plurality of active balancing devices each positioned between the wafer inspection tool and a stage. One example of a wafer inspection tool is the wafer inspection tool 102 of FIG. 1. One example of active balancing devices are the active balancing devices 104 of FIG. 1. One example of a stage is the stage 106 of FIG. 1. At 1004, the method 1000 includes generating sensor signals indicative of an orientation of the wafer inspection tool. At 1006, the method 1000 includes adjusting an orientation of the wafer inspection tool by adjusting at least one of the active balancing devices responsive to the sensor signals.

Embodiments of the present disclosure provide a wafer inspection system that helps ensure that a wafer inspection tool can properly inspect semiconductor wafers by actively leveling the wafer inspection tool and damping vibrations that could otherwise interfere with a wafer inspection process. The wafer inspection system includes a flat stage and a plurality of active balancing devices on the stage. The wafer inspection tool is placed on the active balancing devices such that the active balancing devices support the wafer inspection tool. The system includes one or more sensors that generate sensor signals indicative of an orientation or displacement of the wafer inspection tool. If the sensor signals indicate that the tool is not level or that the tool is vibrating, then the system automatically causes one or more of the active balancing devices to adjust the orientation of the tool or to otherwise damp vibrations of the tool.

In this manner, embodiments of the present disclosure help to ensure that vibrations or other misorientations do not cause the wafer inspection tool to make faulty inspections of wafers. Faulty inspections can result in erroneous analysis indicating that a wafer should be scrapped, when the wafer is, in fact, properly formed. Accordingly, embodiments of the present disclosure result in higher wafer yields, fewer scrapped wafers, and reduced time during which semiconductor processes are interrupted to determine whether or not a particular process has resulted in faulty wafers.

In some embodiments, a system includes a stage, a wafer inspection tool on the stage, and one or more sensors configured to generate sensor signals indicative of an orientation of the wafer inspection tool. The system includes a plurality of active balance devices on the stage between the stage and the wafer inspection tool. The active balancing devices are configured to adjust an orientation of the wafer inspection tool responsive to sensor signals.

In some embodiments, a method includes supporting a wafer inspection tool with a plurality of active balancing devices each positioned between the wafer inspection tool and a stage. The method includes generating sensor signals indicative of an orientation of the wafer inspection tool and adjusting an orientation of the wafer inspection tool by adjusting at least one of the active balancing devices responsive to the sensor signals.

In some embodiments, an active balancing device includes a support surface configured to support a wafer inspection tool and an inflatable chamber. The device includes a control circuit configured to receive sensor signals indicative of an orientation of the wafer inspection tool and to adjust the orientation of the wafer inspection tool by adjusting the inflatable chamber.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A system, comprising:
a stage;
a wafer inspection tool over the stage;
one or more sensors configured to generate sensor signals indicative of an orientation of the wafer inspection tool; and
a plurality of active balance devices between the stage and the wafer inspection tool, wherein the active balancing devices are configured to adjust the orientation of the wafer inspection tool responsive to sensor signals.

2. The system of claim 1, wherein the one or more sensors includes an inertial sensor.

3. The system of claim 2, wherein the sensor signals indicate whether the wafer inspection tool is level, wherein the plurality of active balance devices are configured to adjust the orientation of the wafer inspection tool responsive to the sensor signals indicating that the wafer inspection tool is not level.

4. The system of claim 2, wherein the plurality of active balancing devices are configured to damp vibrations of the wafer inspection tool by moving responsive to the sensor signals.

5. The system of claim 4, wherein the active balancing devices each include a micro-electromechanical system device configured to damp vibrations of the wafer inspection tool.

6. The system of claim 1, wherein the active balancing devices include an inflatable chamber, wherein the active balancing devices adjust the orientation of the wafer inspection tool by adjusting an inflation of the inflatable chamber responsive to the sensor signals.

7. The system of claim 1, comprising a platform positioned on the active balancing devices, wherein the wafer inspection tool is positioned on the platform.

8. The system of claim 1, comprising a plurality of platforms positioned on a respective active balancing device between the active balancing device and the wafer inspection tool.

9. The system of claim 1, comprising a plurality of platforms positioned on a respective pair of the active balancing devices between the pair of active balancing devices and the wafer inspection tool.

10. The system of claim 1, wherein the one or more sensors are coupled to the wafer inspection tool.

11. The system of claim 1, wherein the wafer inspection tool includes a plurality of pivot brackets positioned on a respective active balancing device.

12. A method, comprising:
supporting a wafer inspection tool with a plurality of active balancing devices positioned between the wafer inspection tool and a stage;
generating sensor signals indicative of an orientation of the wafer inspection tool; and
adjusting an orientation of the wafer inspection tool by adjusting at least one of the active balancing devices responsive to the sensor signals.

13. The method of claim 12, wherein adjusting the at least one active balancing device includes adjusting an inflatable chamber of the at least one active balancing device.

14. The method of claim 12, wherein adjusting the orientation of the wafer inspection tool includes leveling the wafer inspection tool.

15. The method of claim 12, wherein adjusting the orientation of the wafer inspection tool includes damping vibrations with active balancing devices.

16. The method of claim 15, wherein damping vibrations includes generating micro-vibrations with MEMS device of the at least one active balancing device.

17. The method of claim 12, comprising supporting the wafer inspection tool with at least one platform positioned between the at least one active balancing device and the wafer inspection tool.

18. A active balancing device, comprising:
a support surface configured to support a wafer inspection tool;
an inflatable chamber; and
a control circuit configured to receive sensor signals indicative of an orientation of the wafer inspection tool and to control an adjustment of the orientation of the wafer inspection tool by adjusting the inflatable chamber.

19. The active balancing device of claim 18, comprising a communication system configured to wirelessly receive the sensor signals.

20. The active balancing device of claim 18 comprising a pump configured to inflate and deflate the inflatable chamber under control of the control circuit.
